(19) United States
(12) Patent Application Publication
(10) Pub. No.: US 2025/0289457 A1
(43) Pub. Date: Sep. 18, 2025

(54) Method for Providing at Least One Trailer Characteristic, Computing Device, Computer-Readable (Storage) Medium, and System

(71) Applicant: Bayerische Motoren Werke Aktiengesellschaft, Muenchen (DE)

(72) Inventor: Michael STROEBEL, Groebenzell (DE)

(21) Appl. No.: 18/862,199

(22) PCT Filed: Apr. 28, 2023
(86) PCT No.: PCT/EP2023/061228

§ 371 Date: Nov. 1, 2024

(30) Foreign Application Priority Data
May 20, 2022 (DE) 10 2022 112 797.4

(51) Int. Cl. B60W 50/14; B60W 30/18; B62D 13/06; G06T 7/50; G06T 7/60; G06T 7/70

(52) U.S. Cl. CPC B60W 50/14; B60W 30/18036; B62D 13/06; G06T 7/50; G06T 7/60; G06T 7/70; B60W 2050/146; B60W 2300/14; B60W 2520/22; B60W 2530/205; G06T 2207/10028; G06T 2207/30252

(57) ABSTRACT

The invention relates to a method for providing at least one characteristic of a trailer, having the steps of receiving image data which describes at least one part of the trailer and a reference object; and detecting the trailer and the reference object in the image data. A method according to the invention may additionally include the steps of determining at least one characteristic of the trailer on the basis of the reference object and outputting the at least one characteristic to a trailer assistance system for a vehicle combination in order to operate the trailer assistance system. Upon detecting the trailer, a coupling point and a central axis of the trailer are additionally detected, and upon determining the at least one trailer characteristic, a drawbar length is determined, wherein the drawbar length describes the distance between the coupling point and the central axis of the trailer.

### BACKGROUND AND SUMMARY

The present invention relates to a method for providing at least one characteristic trailer characteristic variable of a trailer for a trailer assistance system of a vehicle. In addition, the present invention also relates to a computing device, to a computer-readable (storage) medium, and to a system.

Assistance systems for assisting a driver of a vehicle/trailer combination having a vehicle and a trailer have been known for a long time. For example, trailer assistance systems in which a rotary/pushbutton controller can be used to continuously adjust the angle between the trailer and the towing vehicle when resetting the vehicle/trailer combination are known. Furthermore, trailer assistance systems which assist the driver of the towing vehicle when maneuvering the vehicle/trailer combination and warn the driver of collisions are known.

In such assistance systems for assisting a driver of a vehicle/trailer combination, it is advantageous if dimensions of the trailer are known. Some manufacturers rely, for example, on the driver of the vehicle/trailer combination manually inputting the dimensions of the trailer into a vehicle menu. Improved assistance for the driver when maneuvering the vehicle/trailer combination is possible on the basis of the dimensions of the trailer. The driver of the vehicle/trailer combination can therefore be warned of an imminent collision, for example in the case of a veering movement of the trailer.

Document DE 10 2018 206 494 A1 discloses a method for operating a trailer assistance system of a motor vehicle, in which a process of maneuvering a vehicle/trailer combination, formed from the motor vehicle and a trailer, into a target position is assisted by means of the trailer maneuvering assistance system. In this case, the trailer is captured by means of a sensor device of the motor vehicle when the trailer is coupled to the heavy goods vehicle. The sensor data relating to the captured trailer are transferred to an evaluation device of the trailer maneuvering assistance system. In addition, dimensions of the trailer in the longitudinal direction, transverse direction and vertical direction of the trailer are determined by means of the evaluation device on the basis of the transmitted sensor data. Finally, the process of maneuvering the vehicle/trailer combination into the target position is assisted taking into account the determined dimensions of the trailer.

An object of the present invention is to show a solution of how a trailer assistance system for a vehicle can be improved and how a corresponding customer experience can be enhanced when using the trailer assistance system.

This object is achieved, according to forms of the invention, by means of a method, by means of a computing device, by means of a computer-readable (storage) medium and by means of a system having the features according to the independent claims. Advantageous developments of the present invention are specified in the dependent claims.

One form of a method according to the invention for providing at least one characteristic trailer characteristic variable of a trailer for a trailer assistance system of a vehicle comprises receiving image data describing at least one part of the trailer and a reference object. The method according to the invention additionally may comprise identifying the trailer and the reference object in the image data. In addition, the method according to the invention may comprise determining at least one characteristic trailer characteristic variable of the trailer on the basis of the reference object. Finally, the method for operating a trailer assistance system for a vehicle/trailer combination may comprise outputting the at least one characteristic trailer characteristic variable to the trailer assistance system. A coupling point and a central axle of the trailer are additionally identified when identifying the trailer. A towbar length is determined when determining the at least one characteristic trailer characteristic variable, wherein the towbar length describes a distance between the coupling point and the central axle of the trailer.

The vehicle may be in the form of an automobile, for example. In addition, the vehicle may also be a truck, a commercial vehicle, a self-propelled work machine, a recreational vehicle or the like. In particular, the vehicle may also be a tractor, an agricultural or forestry tractor, a semitrailer truck, a bus or the like.

The trailer may be in the form of a simple automobile trailer, for example. Boat trailers, travel trailers, horse trailers, semitrailers, a harvesting machine or the like are likewise also conceivable. The trailer is preferably in the form of an unsteered trailer with at least one rigid axle.

The term of the central axle of a trailer, as used in this document, denotes a (not necessarily real) axle of the trailer which corresponds to the geometric mean of all axles of the trailer. If the trailer has only one axle, for example, the central axle is identical to the one axle of the trailer. If the trailer has exactly two axles, for example, the central axle runs exactly between the two axles. If the trailer has exactly three axles which are distributed equidistantly, for example, the central axle is identical to the centrally arranged axle of the three axles of the trailer. The same applies to four, five, six and/or more axles.

The term of the coupling point, as used in this document, denotes that coupling unit of the trailer which is configured to couple the trailer to the vehicle. If the trailer has a so-called jaw coupling, the coupling jaw forms the coupling point.

The method is therefore intended to be used to determine a characteristic trailer characteristic variable from received image data and to then transmit it to the trailer assistance system. In particular, a towbar length is intended to be determined here.

The method can be carried out by means of a computing device, for example. The computing device may be integrated here in a mobile terminal (smartphone, tablet or the like), for example. However, it is also conceivable for the computing device to be formed by at least one electronic control unit of the vehicle. The computing device may have one or more processors. In addition, the computing device may have a (storage) medium on which a computer program is stored. In order to carry out corresponding method steps, for example the identification of the trailer and the determination of the characteristic trailer characteristic variable, the computer program can be executed on the computing device. All of the method steps can be carried out on the computing device of the mobile terminal or on the mobile terminal. However, it is also conceivable for all of the method steps to be carried out only on an electronic control unit of the vehicle that acts as the computing device. Furthermore, the method steps can be carried out both on the mobile terminal and on the control unit of the vehicle.

A camera of the mobile terminal can therefore be used to initially provide the image data. The image data provided by the mobile terminal can now be received by the computing device of the mobile terminal. The trailer and the reference object can then be identified in the image data by means of the computing device of the mobile terminal. Finally, the at least one characteristic trailer characteristic variable can also be determined. In a subsequent step, the characteristic trailer characteristic variable can be output to the trailer assistance system. In other words, the at least one characteristic trailer characteristic variable can be transmitted from the mobile terminal to the trailer assistance system. In this case, it is conceivable for communication between the mobile terminal and the assistance system to take place via a so-called backend or directly via WLAN, mobile radio, Bluetooth or the like.

In general, it is also conceivable for the trailer and the reference object to be identified in the image data by means of the computing device of the mobile terminal, for example, but for the characteristic trailer characteristic variable to be determined on a further computing device in the vehicle, that is to say an electronic control unit of the vehicle. In other words, a computing device for carrying out corresponding method steps of the method according to the invention may also be in the form of a distributed system.

The image data may comprise a digital image or a sequence of digital images. In particular, the image data may describe the visible wavelength range. The image data may be provided by a camera of a mobile terminal, a camera of the vehicle or the like. The image data may describe a part of the trailer and the reference object. The image data preferably describe, in particular, the at least one part of the trailer which comprises the coupling point of the trailer and the central axle of the trailer. The vehicle, for example, can be described by the image data as the reference object. However, any surface or any object in the environment of the at least one part of the trailer described by the image data may also be identified as the reference object.

Forms of a method according to the invention is preferably based on a so-called augmented reality application. Such an augmented reality application (app) can be executed on a mobile terminal, for example. So that it is possible to measure the three-dimensional trailer in the two-dimensional image data, it is typically necessary for a flat surface to be captured as the reference object. It is therefore possible to use the flat surface to determine a dimension in the image data.

For this purpose, computer vision methods can first of all be used to identify the trailer or the at least one part of the trailer in the image data. In addition, further characteristic points of the trailer can be identified for the purpose of determining the at least one characteristic trailer characteristic variable. For example, the coupling point of the trailer and the central axle of the trailer can therefore be identified using computer vision methods. The towbar length can thus be determined as the distance between the coupling point and the central axle of the trailer on the basis of the reference object, that is to say the flat surface or the vehicle. The at least one characteristic trailer characteristic variable or the towbar length can then be output to the trailer assistance system.

The towbar length of the trailer, that is to say the distance between the coupling point of the trailer and the central axle of the trailer, is an important characteristic variable when maneuvering the vehicle/trailer combination. If the towbar length of the trailer is known, a wide variety of assistance systems for a vehicle/trailer combination can be improved. In particular, trailer assistance systems for reversing or maneuvering a vehicle/trailer combination can be specifically adapted to the corresponding trailer and therefore improved. If the method according to the invention is carried out by means of a mobile terminal, the experience for the customer can be additionally enhanced. Simple task instructions, for instance the creation of one or more digital images of the vehicle/trailer combination or the trailer by the customer or the driver of the vehicle/trailer combination, in conjunction with a noticeable and assisted driving experience on the basis of the image data provided by the driver, can therefore enhance the customer experience overall.

A further advantageous embodiment of the method according to the invention provides for a reversible articulation angle to be determined when determining the at least one characteristic trailer characteristic variable, wherein the reversible articulation angle describes a reversible coupling angle of the vehicle/trailer combination while reversing. The reversible coupling angle of a vehicle/trailer combination is understood as meaning that angle between the longitudinal axis of the towing vehicle, that is to say the vehicle, and the longitudinal axis of the trailer which can be compensated for during reversing of the vehicle/trailer combination without a corrective move in the (forward) direction of travel. In other words, the reversible coupling angle describes the maximum angle between the vehicle and the trailer at which it is still possible to prevent the vehicle/trailer combination from swinging in without a corrective move. In connection with the swinging-in of the vehicle/trailer combination, reference is also made to jack-knifing. Therefore, the reversible coupling angle is also called the jack-knife angle.

The vehicle/trailer combination may swing in during reversing if the coupling angle is increased to such an extent that the vehicle and the trailer fold together around the coupling point. If reversing is continued here, the swinging-in effect is intensified or the coupling angle increases until the vehicle and the trailer touch. The reversible articulation angle, that is to say the critical coupling angle, at which it is still possible to prevent swinging-in can be determined analytically and by simulation. An important characteristic variable for determining the reversible articulation angle may be the towbar length of the trailer. If the at least one characteristic variable includes the reversible articulation angle, this can form the basis for a great potential for improvement in a wide variety of trailer assistance systems.

In addition, it is also advantageous if an overhang length is determined when determining the at least one characteristic trailer characteristic variable, wherein the overhang length describes a distance between one end of a trailer structure of the trailer and the central axle of the trailer. The overhang length of a trailer may be of great importance during a maneuver of the vehicle/trailer combination.

If, for example, the trailer is parked at a distance of less than half a meter, for example, parallel to a further road user, a house wall, a guardrail or the like and the vehicle/trailer combination has a large coupling angle, for example 20° or more, when driving off (in the direction of travel), the result may be a veering movement of the rear of the trailer in the case of a large overhang length. Consequently, this may result in a collision with the further road user, the house wall, the guardrail or the like.

If the end of the trailer structure of the trailer is therefore identified in addition to the central axle of the trailer when identifying the trailer, the overhang length can be determined as the distance between the end of the trailer structure and the central axle of the trailer. If the at least one characteristic trailer characteristic variable includes the overhang length, this can then be output to the trailer assistance system and, if necessary, the trailer assistance system can warn of an imminent collision when driving off, for example. In addition, further assistance functions based on the overhang length, which improve the trailer assistance system and enhance the customer experience, are conceivable.

A further advantageous embodiment of the method according to the invention provides for a drawbar length to be determined when determining the at least one characteristic trailer characteristic variable, wherein the drawbar length describes a distance between a trailer structure of the trailer and the coupling point of the trailer. The drawbar length may be an important characteristic variable, in particular during the so-called jack-knifing. In this case, the drawbar length may be decisive when or at which coupling angle a collision occurs between the vehicle and the structure of the trailer, that is to say the trailer structure. In particular, if so-called towbar boxes are mounted on the towbar of the trailer in front of the trailer structure, the actual drawbar length may be shortened in comparison with the manufacturer specifications for the trailer. As a result, the coupling angle at which the vehicle collides with the structure of the trailer or the towbar box of the trailer can occur already at a smaller coupling angle. In this case, it may also be advantageous if a width of the trailer structure is additionally known.

If a trailer structure or the start of the trailer structure is identified when identifying the trailer, that is to say in addition to the coupling point, the drawbar length can be determined as the distance between the coupling point and the trailer structure as one of the at least one characteristic trailer characteristic variable. The drawbar length can then be output to the trailer assistance system.

Finally, it is also advantageous if, in the method according to the invention, a length, height and/or width of the trailer is/are determined when determining the at least one characteristic trailer characteristic variable. The length, height and/or width of the trailer can likewise be important characteristic variables for trailer assistance systems. For example, the height of the trailer may be relevant to collision warnings when driving through tunnels, garages or the like. The length of the trailer may be decisive, in addition or as an alternative to other characteristic trailer characteristic variables, when maneuvering the vehicle/trailer combination. Overall, a wide variety of trailer assistance systems can therefore thus be improved. It may be particularly advantageous here if all of the above-mentioned characteristic trailer characteristic variables are determined and are output to the trailer assistance system.

A further advantageous embodiment of the method according to the invention provides for the vehicle to be identified as the reference object and for the at least one characteristic trailer characteristic variable of the trailer to be determined on the basis of a dimension of the vehicle, wherein the dimension of the vehicle is determined on the basis of a vehicle model. For example, the towing vehicle or the vehicle can be identified in the image data. In addition, the vehicle model (for example a BMW X5) can be identified. A comparison of the vehicle model with an online database or a stored look-up table may provide a dimension of the vehicle, for example a length of 4.922 m or a length of the rear overhang of the vehicle of 1.073 m. The at least one characteristic trailer characteristic variable can be determined using at least one dimension of the vehicle on the basis of a relative ratio from the image data.

It is also conceivable for the at least one dimension of the vehicle to already be known. For example, a mobile terminal—for providing data (for example outputting the at least one characteristic trailer characteristic variable)—may already be coupled to the vehicle or trailer assistance system. As a result, the vehicle model and/or dimension of the vehicle may already be known in advance, in particular. The at least one characteristic trailer characteristic variable can be determined using the at least one dimension of the vehicle that is thus known in advance on the basis of a relative ratio from the image data.

It may also be advantageous if a sequence of image data describing the at least one part of the trailer and the reference object from different angles is received when receiving the image data. This may be advantageous, in particular, when the method or the recording of the image data is carried out using a mobile terminal which does not have sufficient computing power for augmented reality applications. A sequence of image data, a short video or the like may constitute the required calculation basis for augmented reality calculations on a backend and/or an electronic control unit of the vehicle. In other words, the method according to the invention may therefore itself be carried out on a low-power mobile terminal belonging to the customer or the driver of the vehicle/trailer combination. In addition, it is conceivable for the image data to be checked, corrected and/or adapted by a service provider in real time. This makes it possible to additionally enhance the customer experience and the accuracy of the method.

Finally, it may also be advantageous if image data having additional depth information are received as the image data. In particular, modern mobile terminals, such as smartphones or tablets, nowadays often comprise so-called lidar sensors. Such lidar sensors can be used to provide additional depth information. Image data comprising additional depth information can be used to improve the method according to the invention and its accuracy since a more direct measurement may therefore be possible. Furthermore, it is also conceivable for such depth information to be provided by means of a stereo camera. This is also conceivable since modern mobile terminals often comprise a plurality of cameras.

A computing device according to the invention for providing at least one characteristic trailer characteristic variable of a trailer for a trailer assistance system of a vehicle is configured to receive image data describing at least one part of the trailer and a reference object. In addition, the computing device according to the invention is configured to identify the trailer and the reference object in the image data. In addition, the computing device is configured to determine the at least one characteristic trailer characteristic variable of the trailer on the basis of the reference object and to output the at least one characteristic trailer characteristic variable to the trailer assistance system. Furthermore, the computing device is configured to additionally identify a coupling point and a central axle of the trailer when identifying the trailer, and to determine a towbar length, that is to say a distance between the coupling point and the central axle of the trailer, when determining the at least one characteristic trailer characteristic variable.

The computing device may be, for example, in the form of at least one processor of a mobile terminal, for example a smartphone. The computing device may also be in the form of an electronic control unit, for example. The computing device may comprise one or more programmable processors and a computer-readable (storage) medium. The computing device may also be in the form of a distributed system which comprises a plurality of mutually independent computers each with at least one processor and is presented to the user or the driver as a single system. Such a distributed system may be formed, for example, by the combination of a mobile terminal and an electronic control unit of the vehicle that has already been described at the outset.

A computer-readable (storage) medium according to the invention comprises instructions which, when executed by a computing device, cause the latter to carry out a method according to the invention and the advantageous configurations thereof.

A system according to the invention comprises a computing device according to the invention, a computer-readable (storage) medium according to the invention and a camera for providing image data. The camera may be formed by the vehicle's own camera, for example. However, it is also conceivable for the camera to be a smartphone camera (or a camera of a mobile terminal). It is also conceivable for the system according to the invention to comprise two, three or four cameras.

A further aspect of the invention relates to a computer program comprising instructions which, when the program is executed by a computing device, cause the latter to carry out a method according to the invention and the advantageous configurations thereof. The invention also relates to a vehicle which is configured to operate a trailer assistance system in accordance with the method according to the invention.

The preferred embodiments presented with respect to the method according to the invention and their advantages accordingly apply to the computing device according to the invention, to the computer-readable (storage) medium according to the invention and to the system according to the invention. Furthermore, the preferred embodiments presented with respect to the method according to the invention and their advantages also apply to the computer program according to the invention and to the vehicle according to the invention.

Further features of the invention emerge from the claims, the figures and the description of the figures. The features and combinations of features mentioned above in the description and the features and combinations of features mentioned below in the description of the figures and/or shown in the figures alone can be used not only in the respectively stated combination, but also in other combinations or alone, without departing from the scope of the invention.

### BRIEF DESCRIPTION OF THE DRAWINGS

The invention is now explained in more detail using preferred exemplary embodiments and with reference to the accompanying drawings, in which:

FIG. 1 shows a schematic illustration of a vehicle/trailer combination, comprising a vehicle and a trailer, and an exemplary embodiment of a system according to the invention,

FIG. 2 shows a schematic illustration of the vehicle/trailer combination according to FIG. 1, wherein characteristic trailer characteristic variables are determined with the aid of a mobile terminal and are output to the trailer assistance system, and

FIG. 3 shows a schematic illustration of the trailer, wherein various characteristic trailer characteristic variables are depicted.

### DETAILED DESCRIPTION OF THE DRAWINGS

In the figures, identical or functionally identical elements are provided with the same reference signs.

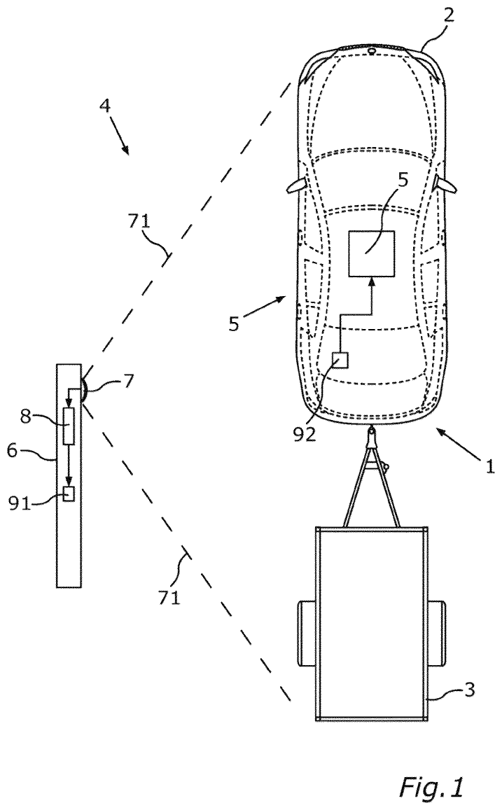

FIG. 1 shows a schematic illustration of a vehicle/trailer combination 1, comprising a vehicle 2 and a trailer 3. The vehicle 2, illustrated here by way of example as an automobile, has an electronic control unit 5 in the exemplary embodiment from FIG. 1. The electronic control unit 5 may be configured to perform functions or method steps of a trailer assistance system. The trailer assistance system may be, for example, an assistance system for the at least partially automated maneuvering of the vehicle/trailer combination 1, a collision warning system or the like.

FIG. 1 also shows an exemplary embodiment of a system 4 according to the invention. The system 4 comprises a camera 7 of a mobile terminal 6, illustrated here as a smartphone, as well as a computing device 8 and a communication device 91. A memory of the mobile terminal 6 and/or a main memory of the computing device 8 may be in the form of a corresponding computer-readable (storage) medium, for example.

The capture range or the field of view of the camera 7 is illustrated by means of the dashed lines 71. The camera 7 can be used to provide image data. In this case, it is also conceivable for image data having additional depth information to be provided. Such depth information can be provided, for example, by means of a lidar sensor of the mobile terminal 6 and/or by means of a stereo camera of the mobile terminal 6.

The computing device 8 of the mobile terminal 6 may receive the image data from the camera 7. The computing device 8 is configured to identify the trailer 3 and a reference object, for example the vehicle 2, in the image data. The computing device 8 can be used to determine at least one characteristic trailer characteristic variable of the trailer 3 on the basis of the reference object. The at least one characteristic trailer characteristic variable can then be transmitted to the electronic control unit 5 of the vehicle 2, for example to a vehicle communication device 92 of the vehicle 2 by means of the communication device 91 of the mobile terminal 6. The at least one characteristic trailer characteristic variable can then be transmitted from the vehicle communication device 92 to the electronic control unit 5 and can therefore be output to the trailer assistance system. In this case, it is conceivable for the at least one characteristic trailer characteristic variable to be transmitted by means of WLAN, Bluetooth, mobile radio or the like, for example.

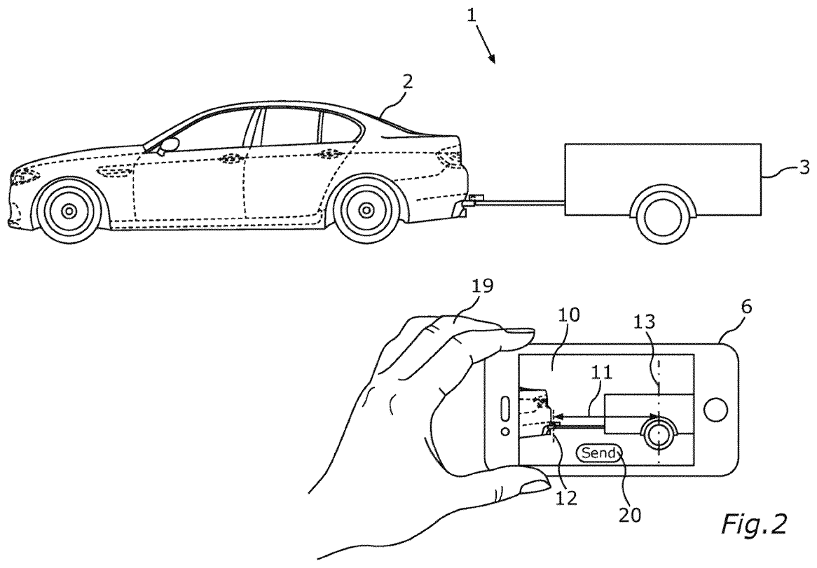

FIG. 2 shows a schematic illustration of a side view of the vehicle/trailer combination 1. The customer or the driver 19 of the vehicle 2 may photograph the vehicle/trailer combination 1 and/or record a video or the like using the mobile terminal 6. The image data can thus be provided. The image data describe here at least one part of the trailer 3 and a reference object. In FIG. 2, the vehicle 2 is the reference object. However, it is also conceivable for the reference object to be formed by a plane. Such reference objects are known, in particular, in the field of augmented reality applications.

The image data are displayed on a display 10 of the mobile terminal 6. In addition, the towbar length 11 of the trailer 3 is displayed on the display 10 of the mobile terminal 6. In this case, the towbar length 11 is displayed as the distance between the coupling point 12 and the central axle 13 of the trailer 3. The towbar length 11 may be determined here by the computing device 8 when determining the at least one characteristic trailer characteristic variable in accordance with the method according to the invention. The at least one characteristic trailer characteristic variable can then be output to the vehicle assistance system by means of a send button 20, for example as illustrated in FIG. 2.

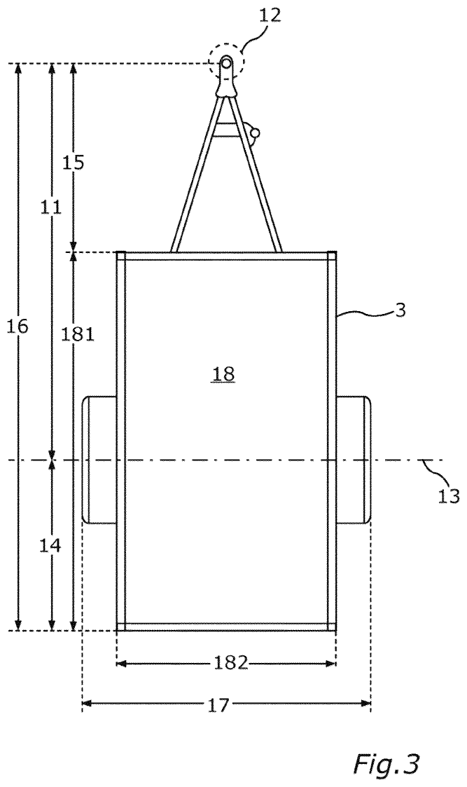

FIG. 3 shows a schematic illustration of the trailer 3 and various characteristic trailer characteristic variables. The towbar length 11, the overhang length 14, the drawbar length 15, the length 16 and the width 17 of the trailer 3 and the dimensions of the trailer structure 18 are illustrated here in FIG. 3. The width of the trailer structure 18 is represented by 181. The length of the trailer structure 18 is represented by 182.

1-11. (canceled)

12. A method for providing at least one characteristic trailer characteristic variable of a trailer for a trailer assistance system of a vehicle, the method comprising:
receiving image data describing at least one part of the trailer and a reference object;
identifying the trailer and the reference object in the image data;
determining the at least one characteristic trailer characteristic variable of the trailer on the basis of the reference object; and
outputting the at least one characteristic trailer characteristic variable to the trailer assistance system;
wherein a coupling point and a central axle of the trailer are further identified when identifying the trailer; and
wherein a towbar length is determined when determining the at least one characteristic trailer characteristic variable, wherein the towbar length is a distance between the coupling point and the central axle of the trailer.

13. The method according to claim 12, wherein:
a reversible articulation angle is determined when determining the at least one characteristic trailer characteristic variable, wherein the reversible articulation angle describes a reversible coupling angle of the vehicle/trailer combination while reversing.

14. The method according to claim 12, wherein:
an overhang length is determined when determining the at least one characteristic trailer characteristic variable, wherein the overhang length describes a distance between one end of a trailer structure of the trailer and the central axle of the trailer.

15. The method according to claims 12, wherein:
a drawbar length is determined when determining the at least one characteristic trailer characteristic variable, wherein the drawbar length is a distance between a trailer structure of the trailer and the coupling point of the trailer.

16. The method according to claim 12, wherein:
at least one of a length, height or width of the trailer is determined when determining the at least one characteristic trailer characteristic variable.

17. The method according to claim 12, wherein:
the vehicle is identified as the reference object and the at least one characteristic trailer characteristic variable of the trailer is determined on the basis of a dimension of the vehicle, wherein the dimension of the vehicle is determined on the basis of a vehicle model.

18. The method according to claim 12, wherein:
a sequence of image data describing the at least one part of the trailer and the reference object from different angles is received when receiving the image data.

19. The method according to claim 12, wherein:
image data having additional depth information are received as the image data.

20. A computing device for providing at least one characteristic trailer characteristic variable of a trailer for a trailer assistance system of a vehicle, the computing device configured to:
receive image data describing at least one part of the trailer and a reference object;
identify the trailer and the reference object in the image data;
determine the at least one characteristic trailer characteristic variable of the trailer on the basis of the reference object;
output the at least one characteristic trailer characteristic variable to the trailer assistance system;
wherein the computing device is further configured such that:
a coupling point and a central axle of the trailer are identified when the trailer is identified; and
a towbar length is determined when determining the at least one characteristic trailer characteristic variable, wherein the towbar length is a distance between the coupling point and the central axle of the trailer.

21. A computer-readable storage medium comprising instructions which, when executed by a computing device, cause the computing device to carry out a method according to 12.

22. A system for a vehicle, comprising:
a computing device for providing at least one characteristic trailer characteristic variable of a trailer for a trailer assistance system of a vehicle, the computing device configured to:
receive image data describing at least one part of the trailer and a reference object;
identify the trailer and the reference object in the image data;
determine the at least one characteristic trailer characteristic variable of the trailer on the basis of the reference object;
output the at least one characteristic trailer characteristic variable to the trailer assistance system;
wherein the computing device is further configured such that:
a coupling point and a central axle of the trailer are identified when the trailer is identified; and
a towbar length is determined when determining the at least one characteristic trailer characteristic variable, wherein the towbar length is a distance between the coupling point and the central axle of the trailer;
a computer-readable storage medium comprising instructions which, when executed by the computing device, cause the computing device to carry out a method according to 12, and
a camera configured to provide image data.
